(19) United States
(12) Patent Application Publication
(10) Pub. No.: US 2024/0358208 A1
(43) Pub. Date: Oct. 31, 2024

(54) NOISE SUPPRESSED VACUUM MOTOR ASSEMBLY

(71) Applicant: LIONSBOT INTERNATIONAL PTE. LTD., Singapore (SG)

(72) Inventor: Wai Peng Benjamin CHAY, Singapore (SG)

(73) Assignee: LIONSBOT INTERNATIONAL PTE. LTD., Singapore (SG)

(21) Appl. No.: 18/688,043

(22) PCT Filed: Mar. 21, 2022
(86) PCT No.: PCT/SG2022/050152

§ 371 Date: Feb. 29, 2024

(51) Int. Cl. A47L 9/00; H02K 5/04; H02K 5/24

(52) U.S. Cl. CPC A47L 9/0081; H02K 5/04; H02K 5/24

(57) ABSTRACT

A noise suppressed vacuum motor assembly (100) comprising: an inner chamber housing (3) having at least one inlet opening (3A) and at least one outlet opening (3B); and a vacuum motor (1) located within the inner chamber housing, with a clearance space (102) provided around the vacuum motor, the vacuum motor, when in use, drawing an airflow through the inner chamber housing from the inlet opening(s) and through the clearance space before exiting through the outlet opening, such that a degree of laminar flow is induced in the airflow when passing through the clearance space.

### FIELD

The present invention generally relates to a noise suppressed vacuum motor assembly. While the present invention will be described with respect to its use of the noise suppressed vacuum motor assembly in vacuum cleaning apparatus, the present invention is not limited to this application, and other applications of the noise suppressed vacuum motor assembly is also envisaged.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Industrial and domestic vacuum cleaners both typically use a vacuum motor to generate the necessary suction required for the operation of the vacuum cleaner. Such vacuum motors can typically produce very high noise levels while in operation. A significant part of the noise comes from turbulent airflow being generated by the vacuum motor when operating.

Conventional methods of isolating vacuum motor noise include the use of acoustic foam, together with one or more kinds of dense material that can act to dampen and prevent sound from passing through from the vacuum motor. However, since any type of vacuum motor must have an air inlet and outlet, this conventional noise suppression method is not sufficient to efficiently isolate the vacuum motor noise. This is because turbulent air is still generated from the operation of the vacuum motor and this results in significant noise generation.

Every vacuum motor also needs air cooling because the motor generates significant heat while in operation. The usage of acoustic foam in the wrong way can result in excessive heating of the vacuum motor reducing its life span. It is therefore, for example, not possible to simply cover the entire vacuum motor in acoustic foam as a noise suppression method.

It would therefore be advantageous to be able to provide noise suppression for a vacuum motor assembly that allows for sufficient airflow to cool the vacuum motor during its operation, while at the same time suppressing as much noise from the vacuum motor assembly as possible.

An object of the invention is therefore to ameliorate one or more of the above-mentioned difficulties.

### SUMMARY

According to an aspect of the present disclosure, there is provided a noise suppressed vacuum motor assembly comprising:
an inner chamber housing having at least one inlet opening and at least one outlet opening; and
a vacuum motor located within the inner chamber housing, with a clearance space provided around the vacuum motor, the vacuum motor, when in use, drawing an airflow through the inner chamber housing from the inlet opening(s) and through the clearance space before exiting through the outlet opening, such that a degree of laminar flow is induced in the airflow when passing through the clearance space.

In some embodiments, the noise suppressed vacuum motor assembly further comprises an inner noise suppression cover mountable on the inner chamber housing over the outlet opening(s), the inner noise suppression cover having a plurality of elongate passages extending in a generally parallel and adjacent relation therethrough; wherein the airflow passing through the elongate passages of the inner noise suppression cover is directed in a same general direction to thereby induce a further degree of laminar flow in the airflow passing through of the inner noise suppression cover.

In some embodiments, the clearance space is in the form of an annular gap, and the elongated passages are provided within an annular region of the inner noise suppression cover that is generally aligned with the clearance space then the inner noise suppression cover is mounted on the inner chamber housing.

In some embodiments, at least some of the elongate passages are positioned on a circular line around a centre of the inner noise suppression cover.

In some embodiments, a plurality of the circular lines of elongate passages are arranged concentrically on the inner noise suppression cover.

In some embodiments, at least some of the elongate passages are positioned in one or more radial lines extending from a centre of the inner noise suppression cover.

In some embodiments, each elongate passage extends from a rear face to a front face of the inner noise suppression cover.

In some embodiments, at least some of the elongate pages taper outwardly from the rear face to the front face thereof.

In some embodiments, the noise suppressed vacuum motor assembly further comprises at least one layer of acoustic foam located over the inner noise suppression cover.

In some embodiments, the noise suppressed vacuum motor assembly further comprises at least one layer of dense material surrounding the inner chamber housing.

In some embodiments, the noise suppressed vacuum motor assembly further comprises at least one layer of dense material located over the inner noise suppression cover.

In some embodiments, the noise suppressed vacuum motor assembly further comprises at least one layer of dense material located over an inlet opening end of the inner chamber housing.

In some embodiments, the dense material is Mass Loaded Vinyl (MLV).

In some embodiments, the vacuum motor is held in place within the inner chamber housing by the inner noise suppression cover, with a resilient spacer located between the vacuum motor and the inner noise suppression cover.

In some embodiments, the resilient spacer is a sponge gasket.

In some embodiments, the clearance space is in the form of a generally annular gap.

In some embodiments, noise suppressed vacuum motor assembly further comprises a support bracket having a cup section for engaging the inner chamber housing.

In some embodiments, the support bracket includes at least one outlet passage passing therethrough which the airflow from the inner chamber housing can exit the noise suppressed vacuum motor assembly.

In some embodiments, the outlet passage(s) is provided through a wall of the cup section.

According to another aspect of the present disclosure, there is provided water tank assembly for a vacuum cleaning apparatus comprising:
a water tank having an elongate cavity therein; and
a noise suppressed vacuum motor assembly as described above positioned within the cavity.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIG. 1 is an exploded view of a noise suppressed vacuum motor assembly according to the present disclosure;

FIG. 2 shows a top view and cross-sectional views respectively taken along lines A-A and B-B of an inner noise suppression cover according to the present disclosure;

FIG. 3 is a perspective view of a water tank within which the noise suppressed vacuum motor noise suppressed vacuum motor assembly of FIG. 1 can be located; and

FIG. 4 is a partial cross-sectional side view of the water tank of FIG. 3 with the noise suppressed vacuum motor noise suppressed vacuum motor assembly installed therein.

Other arrangements of the invention are possible and, consequently, the accompanying drawings are not to be understood as superseding the generality of the preceding description of the invention.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

Example embodiments of the present invention will now be described with reference to the accompanying drawings. The terminology used herein is for the purpose of describing particular embodiments only and is not intended to limit the scope of the present invention. Other definitions for selected terms used herein may be found within the detailed description of the invention and apply throughout the description. Additionally, unless defined otherwise, all technical and scientific terms used herein have the same meanings as commonly understood by one or ordinary skill in the art to which this invention belongs. Where possible, the same reference numerals are used throughout the figures for clarity and consistency.

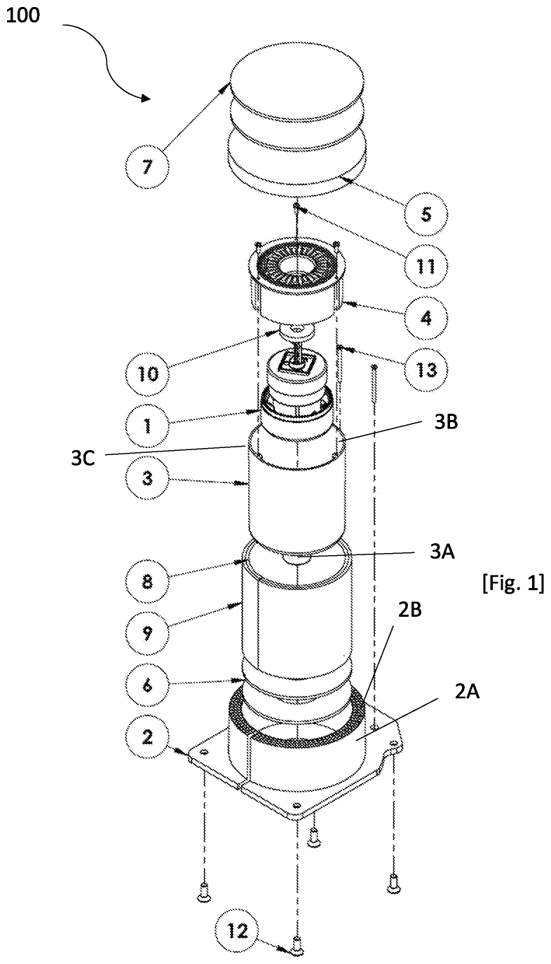

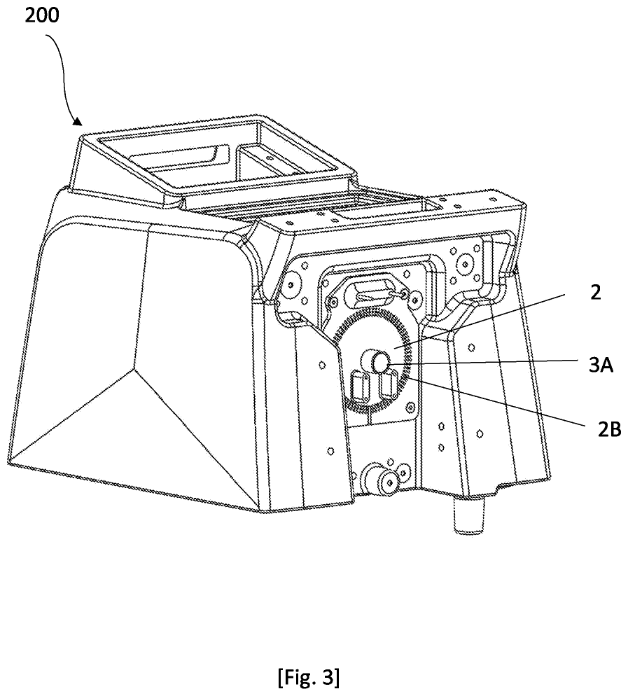

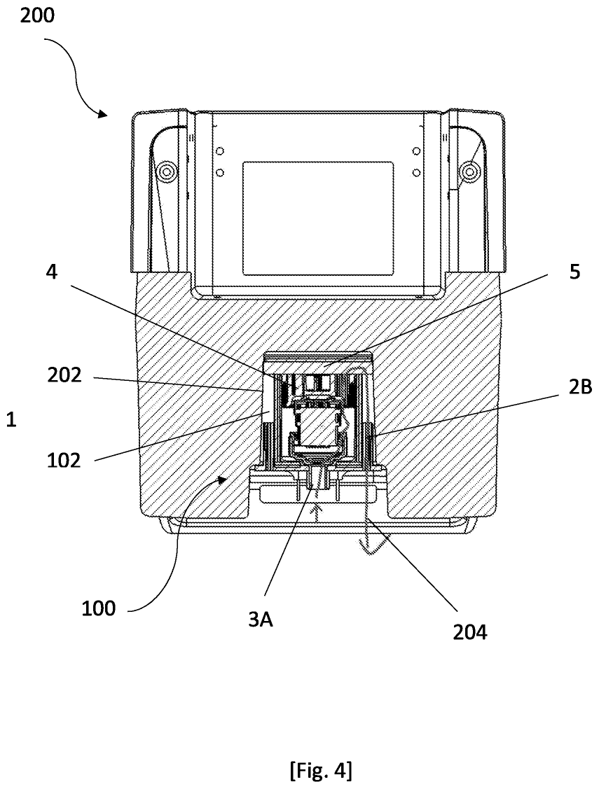

FIG. 1 shows an exploded view of the noise suppressed vacuum motor assembly 100 according to the present disclosure. In an example configuration of the present disclosure, the noise suppressed vacuum motor assembly 100 is located within a water tank 200 (see FIGS. 3 and 4) of an autonomous cleaning robot. The vacuum motor assembly 100 can be accommodated within an internal cavity 202 within the water tank 200. The cavity may be cylindrical in shape and can accommodate the vacuum motor assembly 100 therein.

The noise suppressed vacuum motor assembly 100 includes a vacuum motor 1 located within an inner chamber housing 3. The inner chamber housing 3 may have a generally cylindrical internal volume 3B within which the vacuum motor 1 can be accommodated. A clearance space 102 (see FIG. 4) may therefore be provided between the vacuum motor 1 and the inner chamber housing 3. This clearance space 102 may for example be in the form of a generally annular gap surrounding the vacuum motor 1. The inner chamber housing 3 has an inlet opening/port 3A and an outlet opening/port 3C. It is also envisaged that the inner chamber housing 3 may more than one inlet opening and/or outlet opening. The inlet opening 3A can be provided at one end of the inner chamber housing 3, while the outlet opening 3C can be provided at an opposing end thereof. The inlet opening 3A can be connected to a pipe (not shown). That pipe can be connected to a dirty water tank (not shown) within which any collected dirt or other debris can be sucked in and collected.

The vacuum motor 1 can, when in use, draw air through the inlet opening 3A to thereby provide the necessary suction for the vacuum cleaner of the autonomous cleaning robot. The airflow can pass though the clearance space 102 over the vacuum motor 1 to assist in cooling of the motor before exiting from the inner chamber housing 3 through the outlet opening 3C. The shape of the clearance space 102 can induce a degree of laminar flow in the airflow passing through the clearance space 102. In conventional vacuum cleaners, the operation of the vacuum motor which draws air through the vacuum cleaner will produce significant turbulence within that airflow, which in turn results in substantial noise being generated by the operation of the vacuum motor. This turbulence within the airflow can however be minimised in the noise suppressed vacuum motor assembly 100 according to the present disclosure due to the degree of laminar flow induced in the airflow passing through the inner chamber housing 3. This therefore assists in reducing the turbulence of the air resulting in a reduction in the noise generated by the operation of the vacuum motor 1.

In the embodiment of the noise suppressed vacuum motor assembly 100 according to the present disclosure, an inner noise suppression cover 4 is located over the outlet opening 3C and is secured in place by fasteners such as screws 13 to the inner chamber housing 3. The vacuum motor 1 is held in place within the inner chamber housing 3 by the inner noise suppression cover 4 without the need of any further fasteners. A resilient, for example sponge or rubber, gasket 10 may be located between the vacuum motor 1 and the inner noise suppression cover 4. The cover 4 will therefore press against the gasket 10 when fastened to the inner chamber housing 3, and the gasket 10 will in turn press against the vacuum motor 1 to prevent or minimise movement of the vacuum motor 1 within the inner chamber housing internal volume 3B.

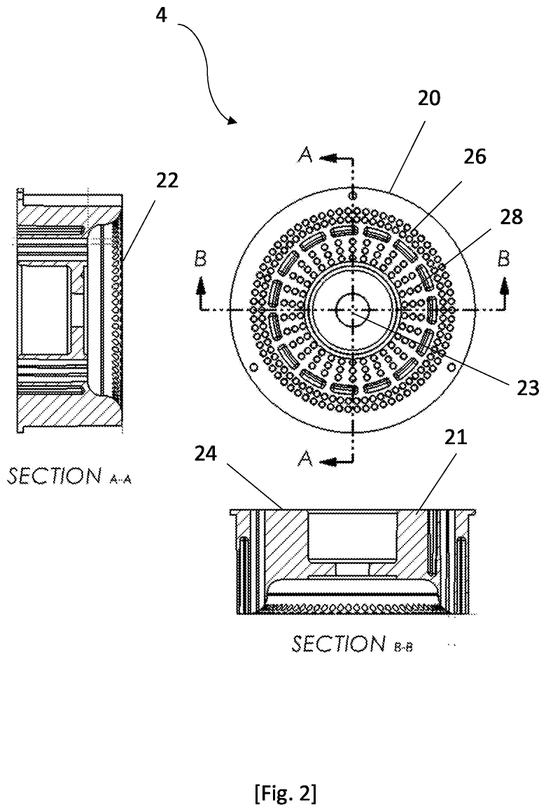

The inner noise suppression cover 4 can further assist in reducing the noise generated by the operation of the vacuum motor 1. Referring to FIG. 2, he inner noise suppression cover 4 comprises a main body 20 which may be generally disc shaped. The main body 20 may have a rear face 22 and a front face 24, and may include a series of elongate passages 26,28 extending in a generally parallel and adjacent relation completely through the inner noise suppression cover 4. The elongate passages 26,28 therefore extend between opposing rear and front faces 22,24 of the cover 4. Some of the elongate passages 26 may be positioned in a circular line around a centre 23 of the cover 4. Two concentric circular lines of passages 26 are shown in fig. 2. Each elongate passage 26 preferably has a generally circular cross-section and may slightly taper outwardly from the rear face 22 towards the front face 24. Each elongate passage 26 may have a diameter of about 2.00 mm at the rear face 22, and a diameter of about 2.40 mm at the front face 24. These elongate passages 26 may have a length of about 38.00 mm. Other of the elongate passages 28 may be positioned along lines extending radially from the cover centre 23 as also shown in FIG. 2. These elongate passages 28 may also have a generally circular cross-section, and may also have a slight outward taper with the diameter of the elongate passage 28 being about 2.00 mm at the rear face 22 and about 2.36 mm at the front face 24. These elongate passages 28 may have a length of about 25.50 mm. Direct measurements were taken of the static pressure achieved by the vacuum motor when unenclosed, when compared with the static pressure achieved when located with a noise suppressed vacuum motor assembly according to the present disclosure. It was found that there would be an approximately 5% drop in static pressure, this pressure drop varying slightly depending on the vacuum motor being tested. This indicates that the inner noise suppressing cover 4 provides minimal restriction for the airflow through the inner chamber housing 3.

These passages may be provided within a generally annular shaped area 21 of the inner noise suppression cover 4. This annular shaped area 21 will be at least substantially aligned with the clearance space 102 between the inner chamber housing 3 and the vacuum motor 1 when the cover 4 is installed. Therefore, the airflow through the clearance space 102 will then be directed to and will subsequently pass though the series of elongate passages 26,28 provided within the annular area 21. The elongate passages 26,28 will then direct the air passing therethough in generally the same direction. This arrangement therefore achieves improved noise suppression by further minimising the turbulence of the air exiting from the elongate passages 26,28 of the inner noise suppression cover 4. This is because a further degree of laminar flow will be induced in the airflow that has passed through the inner noise suppression cover 4 due to the air within the airflow being directed in the same general direction by the elongate passages 26,28. As well as reducing the noise as a result of the reduction or elimination of the turbulent airflow induced by the operation if the vacuum motor 1, the vacuum motor 1 can still be adequately cooled by the airflow over the motor 1 because the inner noise suppression cover 4 preferably provides minimal restriction of the airflow passing through the inner chamber housing 3.

It is also envisaged that the elongate passages 26,28 be positioned in arrangements other than as previously described that can also assist in maximising the air flow though the passages while at the same time maintaining the structural integrity of the inner noise suppression cover 4. While each elongate passage 26,28 is shown as having a generally circular shaped cross-section, it is also envisaged that the elongate passages have alternative cross-sections such as slot shaped or oval shaped cross sections.

Dense material such as, but not restricted to Mass Loaded vinyl (MLV), can also be applied around different parts of the noise suppressed vacuum motor assembly 100 to assist in further reducing the noise being generated by the vacuum motor 1 and turbulent airflow. One or more layers 8, 9 of dense material such as MLV can be provided around the inner chamber housing 3. One or more other layer 6 of dense material can also be provided over the inlet opening end of the inner chamber housing 3 A layer of acoustic insulation foam 5 may also be provided over and pressed on the inner noise suppression cover 4 to further dampen the noise. It is however noted that only a minimal amount of acoustic foam is proposed to be used as the use of more foam can increase air resistance and therefore lessen the efficiency of the vacuum motor 1. One or layers 7 of dense material can then also be laid over the acoustic foam 5, such that an air gap is provided between the dense material layers 7 and the inner noise suppression cover 4, as the air can flow out through the acoustic foam 5. The thickness and number of the dense material layers can vary depending on the space constraints within the cavity 202 of the water tank 200 surrounding the vacuum motor assembly 100. The thickness of each layer when MLV is used may for example be about 6 mm, with the use of thicker material resulting in a further drop in noise level.

The vacuum motor assembly 100 further has a support bracket 2 having a cup section 2A for engaging the inner chamber housing 3 together with the surrounding dense material layers 8,9 on the support bracket 2. Outlet passages 2B may be provided through the wall of the cup section 2A through which the airflow from the inner chamber housing 3 can exit the noise suppressed vacuum motor assembly 100. That support bracket 2 can then be secured to the water tank 200 using fasteners such as screws 12 as shown in FIG. 2, with the vacuum motor assembly 100 thereby being accommodated within the cylindrical cavity 202 provided within the water tank 200 as previously described. FIG. 4 is another view of the water tank showing the noise suppressed vacuum motor assembly 100 installed within the cavity 202. Also shown is the airflow path 204 though the noise suppressed vacuum motor assembly 100 as the vacuum motor 1 is in operation. The airflow passes through the inlet opening 3A and through the clearance space 102 before passing through the inner noise suppression cover 4. The airflow then passes through the acoustic foam layer 5 before reversing in direction and passing through the outlet passages 2B provided with the support bracket cup section 2A.

The use of a noise suppressed vacuum motor assembly according to the present disclosure can lead to a significant suppression in the amount of noise generated by the operation of the vacuum motor due to the reduction or elimination of turbulent airflow, and the increase in laminar flow of the airflow passing through the noise suppressed vacuum motor assembly. Sound measurements tests on an unenclosed vacuum motor found the noise level of that vacuum motor to be about 87 dB. However, the noise level of the vacuum motor when enclosed within a noise suppression vacuum motor assembly according to the present disclosure was found to have dropped to about 65 dB.

It should be appreciated by the person skilled in the art that the above invention is not limited to the embodiment described. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A noise suppressed vacuum motor assembly comprising:
an inner chamber housing having a generally cylindrical internal volume, at least one inlet opening located at one end of the inner chamber housing, and at least one outlet opening located at an opposing end of thereof;
a vacuum motor located within the generally cylindrical internal volume of the inner chamber housing, with a clearance space provided around the vacuum motor, the vacuum motor, when in use, drawing an airflow through the inner chamber housing from the inlet opening(s) and through the clearance space before exiting through the outlet opening, such that a degree of laminar flow is induced in the airflow when passing through the clearance space; and
an inner noise suppression cover mountable on the inner chamber housing over the outlet opening(s), the inner noise suppression cover having a plurality of elongate passages extending in a generally parallel and adjacent relation therethrough;
wherein the airflow passing through the elongate passages of the inner noise suppression cover is directed in a same general direction to thereby induce a further degree of laminar flow in the airflow passing through the inner noise suppression cover.

2. The noise suppressed vacuum motor assembly according to claim 1, wherein the clearance space is in the form of an annular gap, and the elongated passages are provided within an annular region of the inner noise suppression cover that is generally aligned with the clearance space when the inner noise suppression cover is mounted on the inner chamber housing.

3. The noise suppressed vacuum motor assembly according to claim 1, wherein at least some of the elongate passages are positioned on a circular line around a centre of the inner noise suppression cover.

4. The noise suppressed vacuum motor assembly according to claim 3, wherein a plurality of the circular lines of elongate passages are arranged concentrically on the inner noise suppression cover.

5. The noise suppressed vacuum motor assembly according to claim 1, wherein at least some of the elongate passages are positioned in one or more radial lines extending from a centre of the inner noise suppression cover.

6. The noise suppressed vacuum motor assembly according to claim 1, wherein each elongate passage extends from a rear face to a front face of the inner noise suppression cover.

7. The noise suppressed vacuum motor assembly according to claim 6, wherein at least some of the elongate passages taper outwardly from the rear face to the front face thereof.

8. The noise suppressed vacuum motor assembly according to claim 1, further comprising at least one layer of acoustic foam located over the inner noise suppression cover.

9. The noise suppressed vacuum motor assembly according to claim 1, further comprising at least one layer of dense material surrounding the inner chamber housing.

10. The noise suppressed vacuum motor assembly according to claim 9, further comprising at least one layer of dense material located over the inner noise suppression cover.

11. The noise suppressed vacuum motor assembly according to claim 9, further comprising at least one layer of dense material located over an inlet opening end of the inner chamber housing.

12. The noise suppressed vacuum motor assembly according to claim 9, wherein the dense material is Mass Loaded Vinyl (MLV).

13. The noise suppressed vacuum motor assembly according to claim 1, wherein the vacuum motor is held in place within the inner chamber housing by the inner noise suppression cover, with a resilient spacer located between the vacuum motor and the inner noise suppression cover.

14. The noise suppressed vacuum motor assembly according to claim 13, wherein the resilient spacer is a sponge gasket.

15. The noise suppressed vacuum motor assembly according to claim 1, wherein the clearance space is in the form of a generally annular gap.

16. The noise suppressed vacuum motor assembly according to claim 1, further comprising a support bracket having a cup section for engaging the inner chamber housing.

17. The noise suppressed vacuum motor assembly according to claim 16, wherein the support bracket includes at least one outlet passage passing therethrough which the airflow from the inner chamber housing can exit the noise suppressed vacuum motor assembly.

18. The noise suppressed vacuum motor assembly according to claim 17, wherein the outlet passage(s) is provided through a wall of the cup section.

19. A water tank assembly for a vacuum cleaning apparatus comprising:
a water tank having an elongate cavity therein; and
a noise suppressed vacuum motor assembly according to claim 1 positioned within the cavity.

20. (canceled)
